(19) United States
(12) Patent Application Publication
(10) Pub. No.: US 2025/0058292 A1
(43) Pub. Date: Feb. 20, 2025

(54) SYSTEMS, APPARATUSES, UTILIZATION OF MICROWAVE ENERGY WITHIN A MICROWAVE REACTOR

(71) Applicant: Nuionic Technologies, Inc., Fredericton (CA)

(72) Inventors: James M. Tranquilla, Fredericton (CA); Kenneth G. Clark, Fredericton (CA); Tobie Boutot, Fredericton (CA); Jan H. Boshoff, Fredericton (CA)

(21) Appl. No.: 18/562,699

(22) PCT Filed: May 19, 2021
(86) PCT No.: PCT/CA2022/050793

§ 371 Date: Nov. 20, 2023

Related U.S. Application Data
(60) Provisional application No. 63/191,310, filed on May 20, 2021.
(60) Provisional application No. 63/247,062, filed on Sep. 22, 2021.

(51) Int. Cl. B01J 8/04

(52) U.S. Cl. CPC B01J 8/0496; B01J 8/0492; B01J 2208/00442; B01J 2208/00495; B01J 2208/00938

(57) ABSTRACT

There is disclosed is a microwave reactor system for generating a microwave field within a microwave-stimulated conversion zone for effectuating dielectric heating of catalyst material, for catalyzing a reactive process by the heated catalyst material.

### FIELD

The present disclosure relates to microwave reactors.

### BACKGROUND

Existing microwave reactors suffer from inadequate energy utilization.

### SUMMARY

In one aspect, there is provided, a microwave reactor system comprising:
a housing defining a cavity-defining inner surface;
a cavity defined by the cavity-defining inner surface; and
at least one microwave reactor, wherein each one of the at least one microwave reactor, independently, includes: a microwave generator;
an electrode configuration, wherein the electrode configuration includes:
   a first electrode coupled to the microwave generator; and
   a second electrode spaced-apart from the first electrode;
and
a microwave-stimulated conversion zone, defined between the first electrode and the second electrode, and disposed within the cavity;
wherein, for each one of the at least one microwave reactor, independently:
   the microwave generator, the first electrode, the microwave-stimulated conversion zone, and the second electrode are co-operatively configurable in a microwave stimulation-effective configuration;
   in the microwave stimulation-effective configuration, the microwave generator is generating microwave energy, with effect that a microwave field is established within microwave-stimulated conversion zone;
   while the microwave generator, the first electrode, the microwave-stimulated conversion zone, and the second electrode are disposed in a microwave stimulation-effective configuration and catalyst material is disposed within the microwave-stimulated conversion zone, dielectric heating of the catalyst material is effected such that the catalyst material is heated;
   while the dielectric heating of the catalyst material is being effected such that the catalyst material is heated, and reactant material is disposed in a reaction catalyzing-effective proximity to the heated catalyst material, a reactive process is effected and is catalyzed by the heated catalyst material, with effect that heat energy is generated and a reaction product material is produced, such that a respective reaction product material is produced by each one of the at least one microwave reactor, independently, and such that at least one reaction product material is produced by the at least one microwave reactor; and
   the microwave-stimulated conversion zone is disposed in flow communication with the cavity-defining surface, such that:
      the cavity-defining surface is disposed in pressure communication with the microwave-stimulated conversion zone; and
      the cavity-defining surface is disposed in thermal communication with the microwave-stimulated conversion zone.

In another aspect, there is provided, a process for producing reaction product material with the microwave reactor system as described above, comprising:
while: (i) the microwave generator, the first electrode, the microwave-stimulated conversion zone, and the second electrode are disposed in a microwave stimulation-effective configuration and (ii) catalyst material is disposed within the microwave-stimulated conversion zone, such that dielectric heating of the catalyst material is effected with effect that the catalyst material is heated, supplying the feed material to the flow receiving communicator with effect that, for each one of the at least one microwave reactor, a reactant material, deriving from the feed material, becomes disposed in a reaction catalyzing-effective proximity to the heated catalyst material, a reactive process is effected and is catalyzed by the heated catalyst material, with effect that heat energy is generated and a reaction product material is produced, such that, for the at least one microwave reactor, at least one reaction product material is produced; and
discharging a reactor product material, deriving from the at least one reaction product material, via the flow discharging communicator.

In another aspect, there is provided, an apparatus comprising:
a microwave generator;
an electrode configuration, wherein the electrode configuration includes:
   a first electrode coupled to the microwave generator; and
   a second electrode spaced-apart from the first electrode;
and
a microwave-stimulated conversion zone defined between the first and second electrodes;
wherein:
   the microwave generator, the first electrode, the microwave-stimulated conversion zone, and the second electrode are co-operatively configurable in a microwave stimulation-effective configuration;
   in the microwave stimulation-effective configuration, the microwave generator is generating microwave energy, with effect that a microwave field is established within microwave-stimulated conversion zone;
   the first electrode is defined by a flow conductor, wherein the flow conductor includes:
   a flow receiving communicator for receiving a feed material flow;
   a flow distributing communicator; and
   a flow passage that effectuates flow communication between the flow receiving communicator and the flow distributing communicator;
wherein:
   the flow receiving communicator, the flow passage, and the flow distributing communicator are co-operatively configured such that, while the flow receiving communicator is receiving the feed material flow, the flow distributing communicator is discharging a flow of microwave-stimulated conversion zone supply material, derived from the feed material flow, into the microwave-stimulating conversion zone;
and
   the flow receiving communicator, the microwave generator, the electrode configuration, and the microwave-stimulated conversion zone are co-operatively configured such that, while: (i) the feed material flow is being received by the flow receiving communicator such that the microwave-stimulated conversion zone supply material flow is being discharged into the microwave-stimulated conversion zone, and (ii) while the microwave generator, the electrode configuration, and the conversion zone are disposed in the microwave stimulation-effective configuration, at least a fraction of the discharged microwave-stimulated conversion zone supply material flow is converted to a reaction product material via a reactive process, such that a conversion zone material flow, including the reaction product material, becomes established through the microwave-stimulated conversion zone.

In another aspect, there is provided, an apparatus comprising:
a microwave generator;
an electrode configuration, wherein the electrode configuration includes:
   a plurality of first electrodes coupled to the microwave generator; and
   a second electrode spaced-apart from the first electrode;
and
a microwave-stimulated conversion zone, defined between the first electrodes and the second electrode, and disposed within the cavity;
wherein, for each one of the at least one microwave reactor, independently:
   the microwave generator, the first electrodes, the microwave-stimulated conversion zone, and the second electrode are co-operatively configurable in a microwave stimulation-effective configuration;
   in the microwave stimulation-effective configuration, the microwave generator is generating microwave energy, with effect that a microwave field is established within microwave-stimulated conversion zone;
   while the microwave generator, the first electrodes, the microwave-stimulated conversion zone, and the second electrode are disposed in a microwave stimulation-effective configuration and catalyst material is disposed within the microwave-stimulated conversion zone, dielectric heating of the catalyst material is effected such that the catalyst material is heated;
   while the dielectric heating of the catalyst material is being effected such that the catalyst material is heated, and reactant material is disposed in a reaction catalyzing-effective proximity to the heated catalyst material, a reactive process is effected and is catalyzed by the heated catalyst material; and
   at least 50% of the microwave-stimulated conversion zone is spaced apart from at least one of the plurality of first electrodes by a minimum distance of less than 50% of the diameter of the microwave conductor shield.

In another aspect, there is provided an apparatus comprising:
a reaction zone;
a catalyst material disposed within the reaction zone;
a flow conductor including:
   a flow-receiving communicator for receiving flow of a feed material;
   a flow distributing communicator, defined by a plurality of flow-distributing ports longitudinally spaced along the flow conductor; and
   a flow passage that effectuates flow communication between the flow receiving communicator and the flow distributing communicator;
wherein:
   the flow receiving communicator, the flow passage, and the flow distributing communicator are co-operatively configured such that, while the flow receiving communicator is receiving the feed material flow, the flow distributing communicator is discharging a flow of a reactant material, derived from the feed material flow, into the reaction zone.

### BRIEF DESCRIPTION OF DRAWINGS

The embodiments will now be described with reference to the following accompanying drawings, in which:

FIG. 1 is a schematic illustration of an embodiment of an apparatus of the present disclosure; and

FIG. 2 is a schematic illustration of a sectional elevation view of the housing of the apparatus illustrated in FIG. 1, taken along lines A-A;

FIG. 3 is a schematic illustration of a plan view of the apparatus illustrated in FIG. 1, taken along lines B-B;

FIG. 4 is a schematic illustration of a portion of the internal configuration of the apparatus illustrated in FIG. 1; and

FIG. 5 is a schematic illustration of a portion of the internal configuration of an alternative embodiment of an apparatus of the present disclosure; and

FIG. 6 is a schematic illustration of an alternative embodiment of an apparatus of the present disclosure, including multiple microwave reactors.

### DETAILED DESCRIPTION

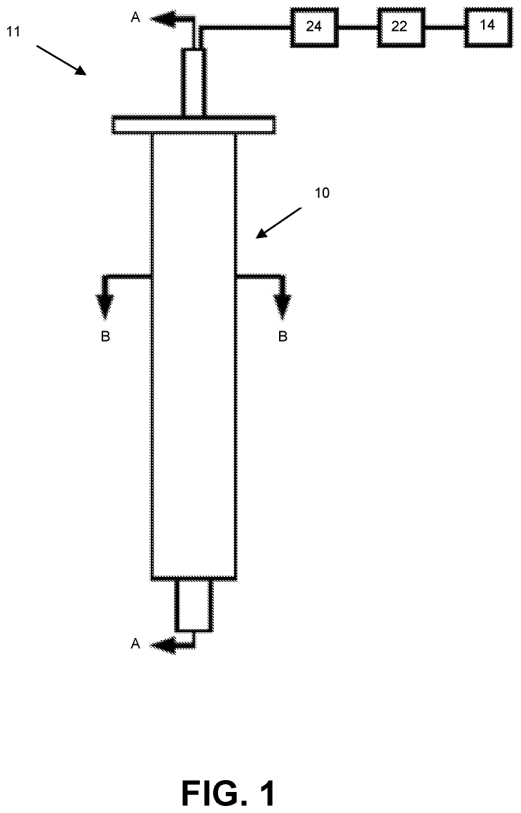

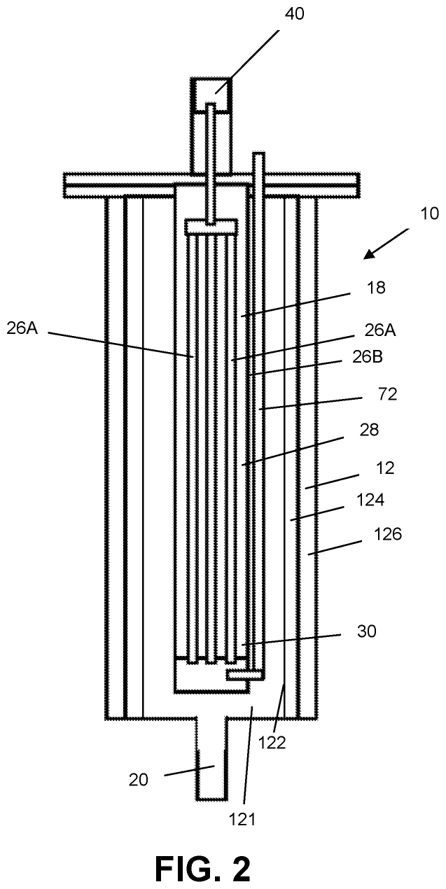

Referring to FIGS. 1 to 6, there is provided an apparatus 10 for converting a feed material, to a microwave-stimulated conversion product material, wherein the conversion is stimulated by microwave energy.

In this respect, in some embodiments, for example, the apparatus 10 includes a microwave reactor 11, and the microwave reactor 11 includes a microwave generator 14 (such as, for example, a magnetron) for generating microwave energy. In some embodiments, the generated microwave energy may fall only within one or more industrial, scientific and medical (ISM) frequencies, such as, for example, about 915 MHz, or about 2450 MHz.

The apparatus 10 further defines a microwave-stimulated conversion zone 18, and co-operates with the microwave generator 14 with effect that the microwave-stimulated conversion zone 18 is disposed for stimulating conversion of convertible material by the generated microwave energy. In some embodiments, for example, the conversion includes a reactive process, and, in such cases, the convertible material includes reactant material.

In some embodiments, for example, for effecting the transmission of microwave energy from the microwave generator 14 to the microwave-stimulated conversion zone 18, the reactor 11 further includes a waveguide 22, a microwave transformer 24, and an electrode configuration 26. The waveguide 22 is coupled to the microwave generator 14 for transmitting a microwave generated by the microwave generator 14 in the waveguide TE₁₀ mode. The microwave transformer 24 is configured for converting the waveguide TE₁₀ mode to the TEM mode. The electrode configuration 26 is coupled to the waveguide 22 via the microwave transformer 24.

The electrode configuration 26 includes a first electrode 26A and a second electrode 26B. In some embodiments, for example, the electrode configuration 26 is a co-axial transmission line including the first electrode 26A and the second electrode 26B. The first electrode 26A is spaced-apart from the second electrode 26B such that an intermediate space 28 is defined between the first electrode 26A and the second electrode 26B. The microwave-stimulated conversion zone 18 is defined within the intermediate space 28. In those embodiments where the electrode configuration is a co-axial transmission line 26, in some of these embodiments, for example, the first electrode 26A is an inner microwave conductor 26A, coupled to the microwave transformer 24, and the second electrode 26B is an outer microwave conductor shield 26B.

In some embodiments, for example, the material of construction of the microwave conductor shield 26B is rated for strength at the temperature and pressure of operation. Typical materials would be alloys of steel, including alloys which are known to be resistant to embrittlement and carbon dusting under highly reducing atmospheres (such as hydrogen and methane).

In some embodiments, for example, the microwave generator 14, the electrode configuration 26, and the microwave-stimulated conversion zone 18 are configurable in a microwave stimulation-effective configuration. In the microwave stimulation-effective configuration, the microwave generator 14 is generating microwave energy (and the generated microwave energy is communicated to the microwave transformer 24 via the waveguide 22, and the microwave transformer 24 induces flow of electric current within the first electrode 26A) with effect that a microwave field is established within the microwave-stimulated conversion zone 18.

While the microwave generator 14, the electrode configuration 26, and the microwave-stimulated conversion zone 18 are disposed in the microwave stimulation-effective configuration, and catalyst material is disposed within the microwave-stimulated conversion zone 18, dielectric heating of the catalyst material is effected such that the catalyst material is heated. In some embodiments, for example, the catalyst material includes metallic material.

While the dielectric heating of the catalyst material is being effected such that the catalyst material is heated, and the reactant material is disposed in a reaction catalyzing-effective proximity to the heated catalyst material, a reactive process is effected and is catalyzed by the heated catalyst material, with effect that heat energy is generated and a reaction product material is produced.

In some embodiments, for example, the catalyst material is defined on at least the surface of particulate material which is disposed within the microwave-stimulated conversion zone 18. In some embodiments, for example, the particulate material defines a bed of particulate material.

In operation, while the reactant material is emplaced within the microwave-stimulated conversion zone 18 and the microwave generator 14 is generating microwave energy (e.g. while the microwave generator 14, the electrode configuration 26, and the conversion zone 18 are disposed in the microwave stimulation-effective configuration), the reactive process is effected within the microwave-stimulated conversion zone 18 such that the reaction product material is obtained.

In some embodiments, for example, the apparatus 10 includes a housing 12. The housing 12 includes a cavity 121 defined by a cavity-defining inner surface 124. The microwave-stimulated conversion zone 18 is defined within the cavity 121. In some embodiments, for example, the housing 12 includes a composite material. The composite material includes a thermally insulating material 126 and a substrate material 128. The thermally insulating material 124 defines at least a portion of the cavity-defining inner surface 122. In some embodiments, for example, the thermally insulating material 124 defines the entirety of the cavity-defining inner surface 122. The thermally insulating material 124 and the substrate material 126 are co-operatively configured such that: the thermally insulating material 124 thermally insulates the substrate material 126 from the cavity 121, and the substrate material 126 reinforces the thermally insulating material 124. In some embodiments, for example, the thermally insulating material 124 is defined by an inner layer of material and the substrate material 126 is defined by an outer layer of material, such that the composite material includes the inner and outer layers of material. In some embodiments, for example, the thermally insulating material 124 defines the outer layer and the substrate material 126 defines the inner layer. In some embodiments, for example, the thermally insulating material 124 is a ceramic material and the substrate material is a metallic material 126. The ceramic material may include, for example, aluminum oxides and silicon nitrides configured in the form of sheets or blankets. The metallic material may comprise, for example, steel alloys.

In some embodiments, for example, each one of the thermally insulating material and the substrate material, independently, has a respective R-value, and the ratio of the R-value of the thermally insulating material to the R-value of the substrate material is at least 5, such as, for example, at least 15, such as, for example, at least 25, such as, for example, at least 35.

In some embodiments, for example, the housing 12 defines a flow receiving communicator 16, the microwave-stimulated conversion zone 18, and a flow discharging communicator 20. In some embodiments, for example, the flow receiving communicator 16 is disposed in flow communication with the flow discharging communicator 20 via the microwave-stimulated conversion zone 18. In some embodiments, for example, the flow receiving communicator 16 is in the form of at least one port, such as, for example, a single port, and is configured for receiving a flow of the feed material (the “feed material flow”). In some embodiments, for example, the flow discharging communicator 20 is in the form of at least one port, such as, for example, a single port, and is configured for discharging a flow of a reactor product material (the “reactor product material flow”), which derives from the reaction product material (and, in some embodiments, the reactor product material flow is a flow of the reaction product material). In this respect, in some embodiments, the flow receiving communicator 16 is disposed in flow communication with the flow discharging communicator 20 via a flow passage 32 extending from the flow receiving communicator 16, through the microwave-stimulated conversion zone 18, and to the flow discharging communicator 20.

In some embodiments, for example, the flow receiving communicator 16, the microwave generator 14, the waveguide 22, the microwave transformer 24, the electrode configuration 26, and the microwave-stimulated conversion zone 18 are co-operatively configured such that, while feed material flow is being received by the flow receiving communicator 16, and while the microwave generator 14, the electrode configuration 26, and the conversion zone 18 are disposed in the microwave stimulation-effective configuration, a conversion zone material flow, that is derived from the feed material flow (the derivation of which is based on flow communication between the flow receiving communicator 16 and the microwave-stimulated conversion zone 18), becomes established through the microwave-stimulated conversion zone 18. In some embodiments, for example, the conversion zone material flow is a flow of any one of: (i) a reactant material, (ii) a reaction intermediate material (i.e. an intermediate material created during the conversion of the feed material to the reaction product material), (iii) a reaction product material, or (iv) a mixture of any combination of (i), (ii), or (iii). In some embodiments, for example, the reactant material is any one of: (i) the feed material, (ii) a microwave-stimulated conversion zone supply material, derived from the feed material, or (iii) a mixture of the feed material and the microwave-stimulated conversion zone supply material.

In those embodiments where the reactive process is catalyzed by catalyst material defined on at least the surface of particulate material which is disposed within the microwave-stimulated conversion zone 18, in some of these embodiments, for example, the particulate material defines a bed of the particulate material that is fluidizable by the conversion zone material flow. In this respect, in some embodiments, for example, a fluidized bed 30 of the particulate material is obtained in response to the establishment of the conversion zone material flow through the microwave-stimulated conversion zone 18, and the catalyzed reactive process is effected while the fluidized bed is established.

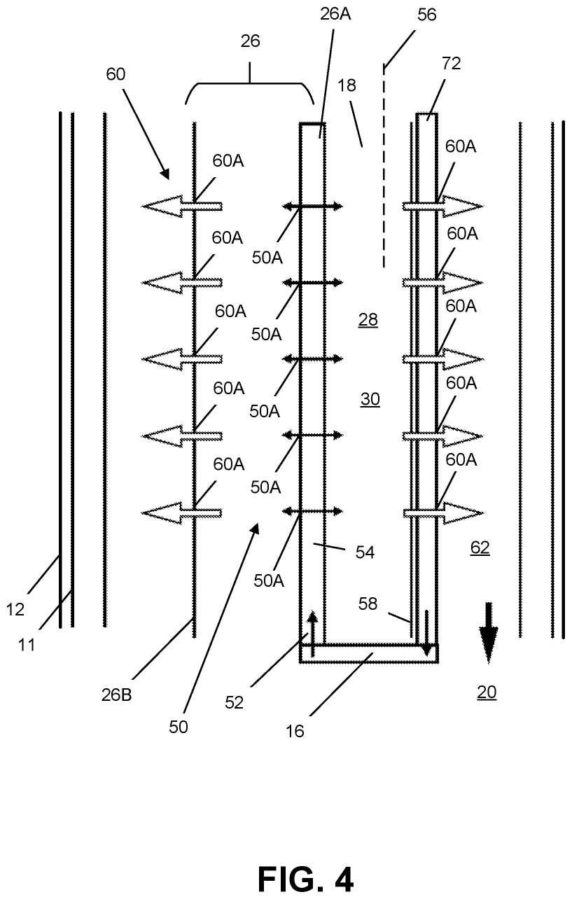

Referring to FIG. 4, in some embodiments, for example, the first electrode 26A is defined by the flow conductor 54. In some embodiments, for example, the flow conductor 54 includes the flow receiving communicator 16, and also includes a flow distributing communicator 50 (e.g. a plurality of flow-distributing ports 50A) for discharging a flow of the microwave-stimulated conversion zone supply material into the conversion zone 18. In some embodiments, for example, the flow communication between the flow receiving communicator 16 and the flow distributing communicator 50, based upon which the conversion zone material flow is established, is effectuated via a flow passage 52 that is defined by a flow conductor 54. The flow passage 52 defines a portion of the flow passage 32

In those embodiments where the flow communicator 50 includes a plurality of flow-distributing ports 50A, in some of these embodiments, for example, the flow-distributing ports 50A are longitudinally spaced along the flow conductor 54. In some embodiments, for example, the flow distributing communicator 50 extends between the flow passage 52 and the microwave-stimulated conversion zone 18 and, in some embodiments, for example, extends from the flow passage 52 to the microwave-stimulated conversion zone 18. In this respect, the flow passage 32 includes the flow passage 52, the flow communicator 50, and the microwave-stimulated conversion zone 18. The flow receiving communicator 16, the flow passage 52, the flow communicator 50, and the microwave-stimulated conversion zone 18 are co-operatively configured such that, while feed material flow is being received by the receiving communicator 16, a microwave-stimulated conversion zone supply material flow, that is derived from the feed material flow (the derivation of the microwave-stimulated conversion zone supply material flow from the feed material flow is based on flow communication between the flow receiving communicator 16 and the flow communicator 50, and, in some embodiments, for example, the microwave-stimulated conversion zone supply material flow is the feed material flow), is discharged from the flow conductor 54 via the flow communicator 50, with effect that the microwave-stimulated conversion zone supply material becomes emplaced within the microwave-stimulated conversion zone 18. In some embodiments, for example, prior to being discharged via the flow communicator 50, the microwave-stimulated conversion zone supply material flow is conducted through the flow passage 52.

In those embodiments where the flow communicator 50 includes a plurality of flow-distributing ports 50A, in some of these embodiments, for example, the discharging of the microwave-stimulated conversion zone supply material flow through the flow-distributing ports 50A is in a direction that is perpendicular to a longitudinal axis 56 of the microwave-stimulated conversion zone 18. In this respect, the discharging of the microwave-stimulated conversion zone material supply flow is along a radial path, relative to the longitudinal axis 56 of the microwave-stimulated conversion zone 18. In some embodiments, for example, the emplacement of the microwave-stimulated conversion zone supply material is with effect that the microwave-stimulated conversion zone supply material is distributed along the longitudinal axis 56. With this configuration, uniform flow, across the longitudinal axis 56 of the microwave-stimulated conversion zone 18, is promoted.

In those embodiments where the electrode configuration 26 is a co-axial transmission line, and the first electrode 26A is an inner microwave conductor 26A, coupled to the microwave transformer 24, and the second electrode 26B is an outer microwave conductor shield 26B, in some of these embodiments, for example, the outer microwave conductor shield 26B is defined by an inner reactor wall 58 disposed within the housing 12, and an intermediate space 62 is defined between the wall 58 and the housing 12. The wall 58 defines a flow communicator 60 (including, in some embodiments, for example, a plurality of ports 60A) for effecting flow communication between the microwave-stimulated conversion zone 18 and the intermediate space 62. In this respect, the reaction product material, within the microwave-stimulated conversion zone 18, from which the reactor product material flow is derived, is disposed in flow communication with the flow discharging communicator 20, via the flow communicator 60 and the intermediate space 62. In this respect, the flow passage 32 includes the flow passage 52, the flow communicator 50, the microwave-stimulated conversion zone 18, the flow communicator 60, and the intermediate space 62.

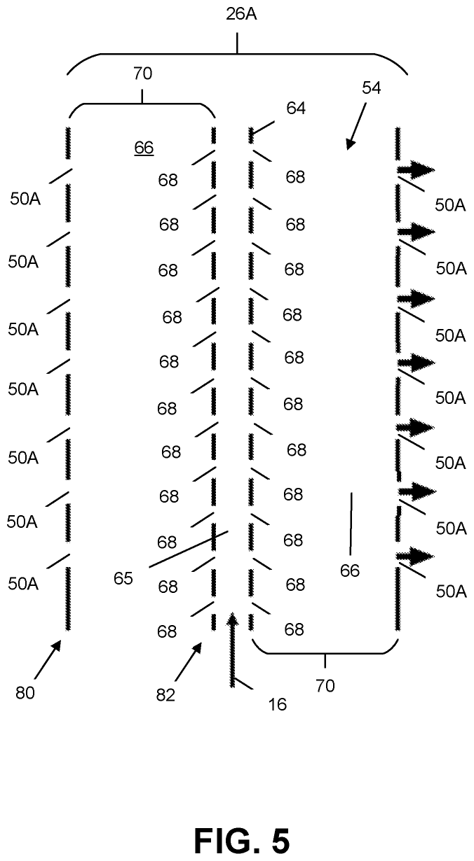

Referring to FIG. 5, in some embodiments, for example, the flow conductor 54 further includes a flow supplying conductor 64, a plurality of flow modulating ports 68 (e.g. ports), and a flow distributing conductor 70. The flow supplying conductor 64 defines a flow supplying passage 65. The flow distributing conductor 70 defines a flow distributing passage 66. Each one of the flow modulating ports 68, independently, extends between the flow supplying passage 65 and the flow distributing passage 66 (and, in some embodiments, for example, extends from the flow supplying passage 65 to the flow distributing passage 66) and effectuates flow communication between the flow supplying passage 65 and the flow distributing passage 66. Each one of the flow-distributing ports 50A, independently, extends between the flow distributing passage 66 and the microwave-stimulated conversion zone 18 (and, in some embodiments, extends from the flow distributing passage 66 to the microwave-stimulated conversion zone 18) and effectuates flow communication between the flow distributing passage 66 and the microwave-stimulated conversion zone 18.

In this respect, the flow passage 52 includes the flow supplying passage 65, the plurality of flow-modulating ports 68, and the flow distributing passage 66. Also in this respect, the flow passage 32 includes the flow supplying passage 65, the plurality of flow-modulating ports 68, the flow distributing passage 66, the plurality of flow-distributing ports 50A, and the microwave-stimulated conversion zone 18. Also in this respect, flow communication is effected, between the flow receiving communicator 16 and the microwave-stimulated conversion zone 18, via the flow supplying passage 65, the plurality of flow-modulating ports 68, the flow distributing passage 66, and the plurality of flow-distributing ports 50A.

In some embodiments, for example, the discharging of the microwave-stimulated conversion zone supply material flow, through the flow-modulating ports 68, is in a direction that is perpendicular to a longitudinal axis 70 of the flow distributing passage 66 (and, also, perpendicular to the longitudinal axis 56 of the microwave-stimulated conversion zone 18). In this respect, in some embodiments, for example, the discharging of the microwave-stimulated conversion zone material supply flow is along a radial path, relative to the longitudinal axis 70 of the flow-distributing passage 66. In some embodiments, for example, the emplacement of the microwave-stimulated conversion zone supply material is with effect that the microwave-stimulated conversion zone supply material is distributed along the longitudinal axis 66. With this configuration, uniform flow, across the longitudinal axis 70 of the flow distributing passage 66, and, as well, the longitudinal axis 56 of the microwave-stimulated conversion zone 18) is promoted.

In some embodiments, for example, the flow-modulating ports 68 and the flow-distributing ports 50A are co-operatively configured such that, for each one of the flow-modulating ports 68, independently, and relative to every one of the flow-distributing ports 50A, the cross-sectional flow area of the flow-modulating port 68 is smaller than the cross-sectional flow area of the flow-distributing port 50A. In some embodiments, for example, the flow-modulating ports 68 and the flow distributing ports 50A are co-operatively configured such that, for each one of the flow-modulating ports 68, independently, and relative to every one of the flow-distributing ports 50A, the ratio of the cross-sectional flow area of the flow-modulating port 68 to the cross-sectional flow area of the flow distributing port 50A is less than 0.5. In some embodiments, for example, each one of the flow-modulating ports 68, independently, is disposed in alignment with a respective one of the flow-distributing ports 50A.

Referring again to FIG. 5, in some embodiments, for example, the flow conductor 54 is defined by a nested conductor housing configuration that includes an outer conductor housing 80 and an inner conductor housing 82. The outer conductor housing 80 and the inner conductor housing 82 are co-operatively configured such that: the inner conductor housing 82 is nested within the outer conductor housing 80, the flow supplying passage 65 is defined within the inner conductor housing 82, the plurality of flow-modulating ports 68 extend through the inner conductor housing 82, the flow distributing passage 66 is defined between the inner conductor housing 82 and the outer conductor housing 84, and the flow distributing ports 50A extend through the outer conductor housing 84.

By adopting this configuration, in addition to the promotion of uniform flow across the longitudinal axis of the microwave-stimulated conversion zone 18, potential plugging of the smaller flow ports 68, by catalyst material, is also mitigated.

In some embodiments, for example, a flow conductor 72 is provided to supply feed material flow to the flow receiving communicator 16. In some of these embodiments, for example, the housing 12, the inner reactor wall 12, and the flow conductor 72 are co-operatively configured such that the flow conductor 72 is disposed in indirect heat transfer communication relative to the inner reactor wall 58 for heating feed material flow being conducted through the flow conductor with heat generated in response to the conversion within the microwave-stimulated conversion zone 18.

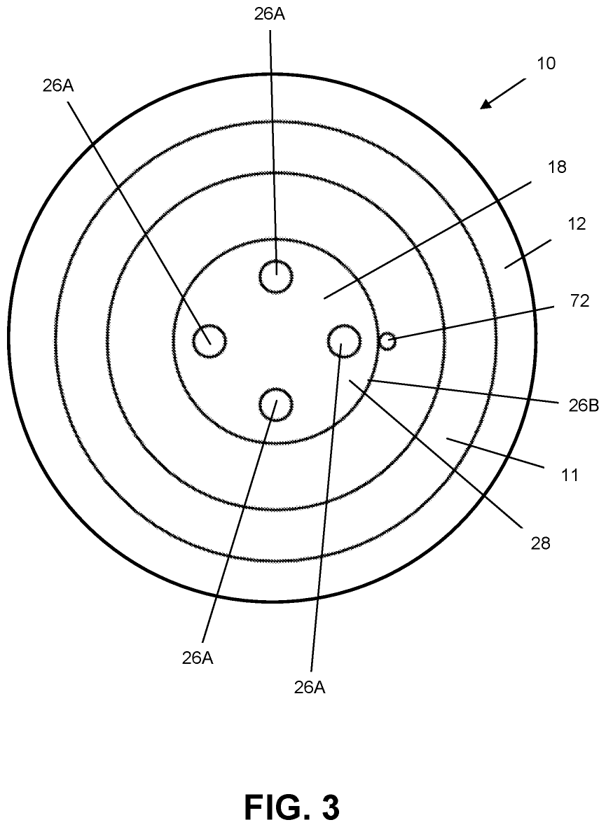

Referring to FIG. 3, in some embodiments, for example, the apparatus 10 includes a plurality of microwave conductors 26A, such that a multi-electrode configuration is provided and includes a plurality of microwave conductors 26A. In this respect, in some embodiments, for example, at least 50% of the microwave-stimulated conversion zone 18 (such as, for example, at least 60% of the microwave-stimulated conversion zone 18, such as, for example, at least 70% of the microwave-stimulated conversion zone 18) is spaced apart from at least one of the plurality of microwave conductors 26A by a minimum distance of less than 50% of the diameter of the microwave conductor shield 26B (such as, for example, less than 40% of the diameter of the microwave conductor shield 26B, such as, for example, less than 30% of the diameter of the microwave conductor shield 26B).

In operation, the feed material flow is received by the flow receiving communicator 14, the microwave-stimulated conversion zone material supply flow, derived from the feed material, is discharged through the flow communicator 50 in a direction that is perpendicular to a longitudinal axis 56 of the microwave-stimulated conversion zone 18, with effect that the microwave-stimulated conversion zone supply material becomes emplaced within the microwave-stimulated conversion zone 18. In some embodiments, for example, the emplacement is such that the microwave-stimulated conversion zone supply material is longitudinally distributed within the microwave-stimulated conversion zone 18. While the microwave generator 14, the electrode configuration 26, and the microwave-stimulated conversion zone 18 are disposed in the microwave stimulation-effective configuration, and the microwave-stimulated conversion zone supply material is emplaced within the microwave-stimulated conversion zone 18 in a reaction catalyzing-effective proximity to the heated catalyst material (catalyst material which is heated via dielectric heating), a reactive process is effected and is catalyzed by the heated catalyst material, with effect that heat energy is generated and a reaction product material flow is produced, and a reactor product material flow, derived from the reaction product material flow (in some embodiments, for example, the reactor product material flow is the reaction product material flow), is discharged through the flow discharging communicator 20.

In some embodiments, for example, the receiving of the feed material flow by the flow receiving communicator 16, the emplacement of the microwave-stimulated conversion zone supply material within the microwave-stimulated conversion zone 18, the conversion of the microwave-stimulated conversion zone supply material into reaction product material, and the discharging of the reactor product material flow is continuous.

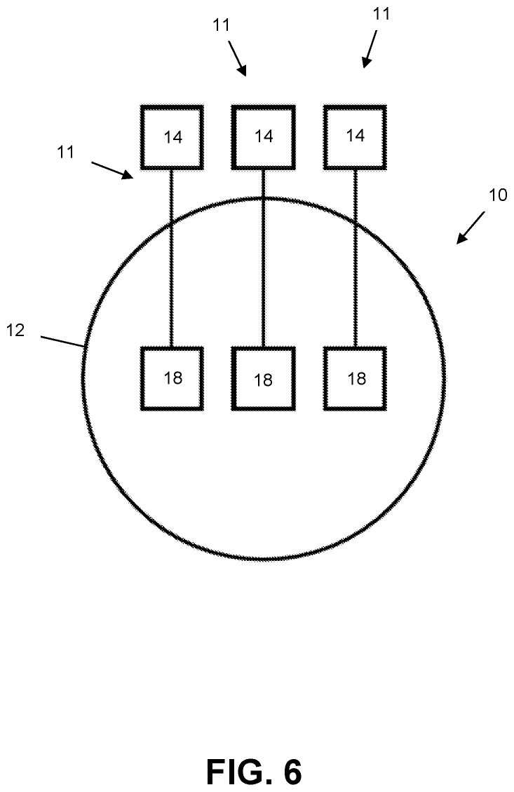

Referring to FIG. 6, in some embodiments, for example, the apparatus 10 includes a plurality of microwave reactors 11, and the plurality of microwave reactors 11 are disposed within the housing 12. In this respect, a respective reaction product material is produced by each one of the microwave reactors, such that a plurality of reaction product materials are produced, and the reactor product material is derived from the plurality of reaction product materials.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A microwave reactor system comprising:
a housing defining a cavity-defining inner surface;
a cavity defined by the cavity-defining inner surface;
and
at least one microwave reactor, wherein each one of the at least one microwave reactor, independently, includes:
a microwave generator;
an electrode configuration, wherein the electrode configuration includes:
a first electrode coupled to the microwave generator; and
a second electrode spaced-apart from the first electrode;
and
a microwave-stimulated conversion zone, defined between the first electrode and the second electrode, and disposed within the cavity;
wherein, for each one of the at least one microwave reactor, independently:
the microwave generator, the first electrode, the microwave-stimulated conversion zone, and the second electrode are co-operatively configurable in a microwave stimulation-effective configuration;
in the microwave stimulation-effective configuration, the microwave generator is generating microwave energy, with effect that a microwave field is established within the microwave-stimulated conversion zone;
while the microwave generator, the first electrode, the microwave-stimulated conversion zone, and the second electrode are disposed in a microwave stimulation-effective configuration and catalyst material is disposed within the microwave-stimulated conversion zone, dielectric heating of the catalyst material is effected such that the catalyst material is heated;
while the dielectric heating of the catalyst material is being effected such that the catalyst material is heated, and reactant material is disposed in a reaction catalyzing-effective proximity to the heated catalyst material, a reactive process is effected and is catalyzed by the heated catalyst material, with effect that heat energy is generated and a reaction product material is produced, such that a respective reaction product material is produced by each one of the at least one microwave reactor, independently, and such that at least one reaction product material is produced by the at least one microwave reactor;
and
the microwave-stimulated conversion zone is disposed in flow communication with the cavity-defining surface, such that:
the cavity-defining surface is disposed in pressure communication with the microwave-stimulated conversion zone; and
the cavity-defining surface is disposed in thermal communication with the microwave-stimulated conversion zone.

2. The microwave reactor system as claimed in claim 1;
wherein:
the at least one microwave reactor is a plurality of microwave reactors, such that the at least one reaction product material is a plurality of reaction product materials.

3. The microwave reactor system as claimed in claim 2;
wherein:
the housing includes a composite material;
the composite material includes a thermally insulating material and a substrate material;
the thermally insulating material defines at least a portion of the cavity-defining inner surface; and
the thermally insulating material and the substrate material are co-operatively configured such that:
the thermally insulating material thermally insulates the substrate material from the cavity; and
the substrate material reinforces the thermally insulating material;

4. The microwave reactor system as claimed in claim 3;
wherein:
each one of the thermally insulating material and the substrate material, independently, has a respective R-value; and
the ratio of the R-value of the thermally insulating material to the R-value of the substrate material is at least 5.

5. (canceled)

6. (canceled)

7. (canceled)

8. (canceled)

9. (canceled)

10. (canceled)

11. (canceled)

12. The microwave reactor system as claimed in claim 4;
wherein:
each one of the at least one microwave reactor, independently, is disposed within the cavity, such that for each one of the at least one microwave reactor, independently, the disposition of the microwave reactor within the cavity establishes the disposition of the microwave-stimulated conversion zone within the cavity.

13. A process for producing reaction product material with the microwave reactor system as claimed in claim 12, comprising:
while: (i) the microwave generator, the first electrode, the microwave-stimulated conversion zone, and the second electrode are disposed in a microwave stimulation-effective configuration, and (ii) catalyst material is disposed within the microwave-stimulated conversion zone, such that dielectric heating of the catalyst material is effected with effect that the catalyst material is heated, supplying the feed material to the flow receiving communicator with effect that, for each one of the at least one microwave reactor, a reactant material, deriving from the feed material, becomes disposed in a reaction catalyzing-effective proximity to the heated catalyst material, a reactive process is effected and is catalyzed by the heated catalyst material, with effect that heat energy is generated and a reaction product material is produced, such that, for the at least one microwave reactor, at least one reaction product material is produced; and
discharging the reactor product material, deriving from the at least one reaction product material, via the flow discharging communicator.

14. (canceled)

15. (canceled)

16. An apparatus comprising:
a microwave generator;
an electrode configuration, wherein the electrode configuration includes:
a first electrode coupled to the microwave generator; and
a second electrode spaced-apart from the first electrode;
and
a microwave-stimulated conversion zone defined between the first and second electrodes;
wherein:
the microwave generator, the first electrode, the microwave-stimulated conversion zone, and the second electrode are co-operatively configurable in a microwave stimulation-effective configuration;
in the microwave stimulation-effective configuration, the microwave generator is generating microwave energy, with effect that a microwave field is established within microwave-stimulated conversion zone;
the first electrode is defined by a flow conductor, wherein the flow conductor includes:
a flow receiving communicator for receiving a feed material flow;
a flow distributing communicator; and
a flow passage that effectuates flow communication between the flow receiving communicator and the flow distributing communicator;
wherein:
the flow receiving communicator, the flow passage, and the flow distributing communicator are co-operatively configured such that, while the flow receiving communicator is receiving the feed material flow, the flow distributing communicator is discharging a flow of microwave-stimulated conversion zone supply material, derived from the feed material flow, into the microwave-stimulating conversion zone;
and
the flow receiving communicator, the microwave generator, the electrode configuration, and the microwave-stimulated conversion zone are co-operatively configured such that, while: (i) the feed material flow is being received by the flow receiving communicator such that the microwave-stimulated conversion zone supply material flow is being discharged into the microwave-stimulated conversion zone, and (ii) while the microwave generator, the electrode configuration, and the conversion zone are disposed in the microwave stimulation-effective configuration, at least a fraction of the discharged microwave-stimulated conversion zone supply material flow is converted to a reaction product material via a reactive process, such that a conversion zone material flow, including the reaction product material, becomes established through the microwave-stimulated conversion zone.

17. The apparatus as claimed in claim 16;
wherein:
a longitudinal axis is defined though the microwave-stimulated conversion zone; and
the flow distributing communicator is defined by a plurality of flow-distributing ports longitudinally spaced along the flow conductor.

18. The apparatus as claimed in claim 17;
wherein:
the flow conductor and the microwave-stimulated conversion zone are co-operatively configured such that the discharging of the microwave-stimulated conversion zone supply material flow, through the flow-distributing ports, is in a direction that is perpendicular to the longitudinal axis of the microwave-stimulated conversion zone.

19. The apparatus as claimed in claim 18;
wherein:
the flow conductor and the microwave-stimulated conversion zone are co-operatively configured such that the discharging of the microwave-stimulated conversion zone supply material, through the flow-distributing ports, is with effect that the microwave-stimulated conversion zone supply material is distributed along the longitudinal axis of the microwave-stimulated conversion zone.

20. The apparatus as claimed in claim 19;
further comprising:
catalyst material disposed within the microwave-stimulated conversion zone.

21. (canceled)

22. The apparatus as claimed in claim 20;
wherein:
the flow receiving communicator, the microwave generator, the electrode configuration, and the microwave-stimulated conversion zone are further co-operatively configured such that, while: (i) the feed material flow is being received by the flow receiving communicator such that the microwave-stimulated conversion zone supply material flow is being discharged into the microwave-stimulated conversion zone, and (ii) while the microwave generator, the electrode configuration, and the conversion zone are disposed in the microwave stimulation-effective configuration:
dielectric heating of the catalyst material is effected such that the catalyst material is heated; and
the reactive process is catalyzed by the heated catalyst material.

23. The apparatus as claimed in claim 22;
wherein:
the flow conductor further includes a flow supplying conductor, a plurality of flow modulating ports, and a flow distributing conductor;
the flow supplying conductor defines a flow supplying passage;
the flow distributing conductor defines a flow distributing passage;
each one of the flow modulating ports, independently, extends between the flow supplying passage and the flow distributing passage and effectuates flow communication between the flow supplying passage and the flow distributing passage;
each one of the flow-distributing ports, independently, extends between the flow distributing passage and the microwave-stimulated conversion zone and effectuates flow communication between the flow distributing passage and the microwave-stimulated conversion zone; and
the flow-modulating ports and the flow-distributing ports are co-operatively configured such that, for each one of the flow-modulating ports, independently, and relative to every one of the flow-distributing ports, the cross-sectional flow area of the flow-modulating port is smaller than the cross-sectional flow area of the flow-distributing port.

24. The apparatus as claimed in claim 23;
wherein:
the flow-modulating ports and the flow distributing ports are further co-operatively configured such that, for each one of the flow-modulating ports, independently, and relative to every one of the flow-distributing ports, the ratio of the cross-sectional flow area of the flow-modulating port to the cross-sectional flow area of the flow distributing port is less than 0.5.

25. The apparatus as claimed in claim 24;
further comprising:
a housing, defining:
the flow receiving communicator; and
a flow discharging communicator for discharging a reactor product material flow that is derived from the reaction product material.

26. The apparatus as claimed in claim 25;
wherein:
the electrode configuration is a co-axial transmission line.

27. An apparatus comprising:
a microwave generator;
an electrode configuration, wherein the electrode configuration includes:
a plurality of first electrodes coupled to the microwave generator; and
a second electrode spaced-apart from the first electrode;
and
a microwave-stimulated conversion zone, defined between the first electrodes and the second electrode, and disposed within the cavity;
wherein, for each one of the at least one microwave reactor, independently:
the microwave generator, the first electrodes, the microwave-stimulated conversion zone, and the second electrode are co-operatively configurable in a microwave stimulation-effective configuration;
in the microwave stimulation-effective configuration, the microwave generator is generating microwave energy, with effect that a microwave field is established within microwave-stimulated conversion zone;
while the microwave generator, the first electrodes, the microwave-stimulated conversion zone, and the second electrode are disposed in a microwave stimulation-effective configuration and catalyst material is disposed within the microwave-stimulated conversion zone, dielectric heating of the catalyst material is effected such that the catalyst material is heated;
while the dielectric heating of the catalyst material is being effected such that the catalyst material is heated, and reactant material is disposed in a reaction catalyzing-effective proximity to the heated catalyst material, a reactive process is effected and is catalyzed by the heated catalyst material; and
at least 50% of the microwave-stimulated conversion zone is spaced apart from at least one of the plurality of first electrodes by a minimum distance of less than 50% of the diameter of the microwave conductor shield.

28. An apparatus comprising:
a reaction zone;
a catalyst material disposed within the reaction zone;
a flow conductor including:
a flow-receiving communicator for receiving flow of a feed material;
a flow distributing communicator, defined by a plurality of flow-distributing ports longitudinally spaced along the flow conductor; and
a flow passage that effectuates flow communication between the flow receiving communicator and the flow distributing communicator;
wherein:
the flow receiving communicator, the flow passage, and the flow distributing communicator are co-operatively configured such that, while the flow receiving communicator is receiving the feed material flow, the flow distributing communicator is discharging a flow of a reactant material, derived from the feed material flow, into the reaction zone.

29. (canceled)

30. The apparatus as claimed in claim 28;
wherein:
a longitudinal axis is defined through the reaction zone; and
the flow conductor and the reaction zone are co-operatively configured such that the discharging of the reactant material flow, through the flow-distributing ports, is in a direction that is perpendicular to the longitudinal axis of the reaction zone.

31. The apparatus as claimed in claim 30;
wherein:
the flow conductor and the reaction zone are co-operatively configured such that the discharging of the reactant material flow, through the flow-distributing ports, is with effect that the reactant material flow is distributed along the longitudinal axis of the reaction zone.

32. The apparatus as claimed in claim 31;
wherein:
the flow conductor further includes a flow supplying conductor, a plurality of flow modulating ports, and a flow distributing conductor;
the flow supplying conductor defines a flow supplying passage;
the flow distributing conductor defines a flow distributing passage
each one of the flow modulating ports, independently, extends between the flow supplying passage and the flow distributing passage and effectuates flow communication between the flow supplying passage and the flow distributing passage;
each one of the flow-distributing ports, independently, extends between the flow distributing passage and the reaction zone and effectuates flow communication between the flow distributing passage and the reaction zone; and
the flow-modulating ports and the flow-distributing ports are co-operatively configured such that, for each one of the flow-modulating ports, independently, and relative to every one of the flow-distributing ports, the cross-sectional flow area of the flow-modulating port is smaller than the cross-sectional flow area of the flow-distributing port.

33. The apparatus as claimed in claim 32;
wherein:
the flow-modulating ports and the flow distributing ports are further co-operatively configured such that, for each one of the flow-modulating ports, independently, and relative to every one of the flow-distributing ports, the ratio of the cross-sectional flow area of the flow-modulating port to the cross-sectional flow area of the flow distributing port is less than 0.5.

34. (canceled)
